(19) United States
(12) Patent Application Publication
(10) Pub. No.: US 2010/0237757 A1
(43) Pub. Date: Sep. 23, 2010

(54) Distribution Hubs

(75) Inventors: George I. Wakileh, Batavia, IL (US); Eduardo Leon, Woodridge, IL (US); Simon Shen-Meng Chen, Palatine, IL (US)

Correspondence Address: HARNESS, DICKEY, & PIERCE, P.L.C, 7700 Bonhomme, Suite 400, ST. LOUIS, MO, 63105, US

(73) Assignee: Emerson Network Power, Energy Systems, North America, Inc., Warrenville, IL (US)

(21) Appl. No.: 12/727,714

(22) Filed: Mar. 19, 2010

Related U.S. Application Data
(60) Provisional application No. 61/162,128, filed on Mar. 20, 2009.

(51) Int. Cl. A47B 96/00; F16M 11/22; A47B 81/00

(52) U.S. Cl. 312/312; 312/294; 248/188.8

(57) ABSTRACT

Distribution hubs and telecommunications enclosures are disclosed. One example distribution hub includes a cover section and a mounting section. The mounting section is adapted to support telecommunications cables and/or equipment. The cover section is coupled to the mounting section to permit movement of the cover section relative to the mounting section along an axis and between an extended position in which a portion of the mounting section is exposed and a retracted position in which such portion of the mounting section is substantially covered by the cover section.

### CROSS-REFERENCE TO RELATED APPLICATIONS

This application claims the benefit of U.S. Provisional Application No. 61/162,128 filed on Mar. 20, 2009. The entire disclosure of the above application is incorporated herein by reference.

### FIELD

The present disclosure relates generally to distribution hubs and telecommunications enclosures including distribution hubs.

### BACKGROUND

This section provides background information related to the present disclosure which is not necessarily prior art.

Telecommunications enclosures are commonly used in telecommunications networks to distribute telecommunications services, such as television, telephone, internet, etc. The telecommunications enclosures often contain connections between cables and equipment for distribution of the telecommunications network (e.g., fiber optic, copper, or other). The telecommunications enclosures are usually configured to prevent the ingress of weather, debris and rodents, which may damage, disrupt, and/or inhibit the integrity of the telecommunications network. Telecommunications pedestal enclosures, for example, are known to include a base and a cover engaged with and removable from the base for protecting cables and/or equipment within the pedestal enclosure.

### SUMMARY

This section provides a general summary of the disclosure, and is not a comprehensive disclosure of its full scope or all of its features.

According to one aspect of the present disclosure, a telecommunications pedestal enclosure includes a distribution hub, a base for supporting the distribution hub, and a dome releasably couplable to the base for substantially enclosing the distribution hub when the distribution hub is supported by the base and the dome is releasably coupled to the base. The distribution hub includes a cover section and a mounting section. The mounting section is adapted to support telecommunications cables and/or equipment. The cover section is moveable relative to the mounting section along an axis and between an extended position in which a portion of the mounting section is exposed and a retracted position in which such portion of the mounting section is substantially covered by the cover section.

According to another aspect of the present disclosure, a distribution hub includes a cover section and a mounting section. The mounting section is adapted to support telecommunications cables and/or equipment. The cover section is coupled to the mounting section to permit movement of the cover section relative to the mounting section along an axis and between an extended position in which a portion of the mounting section is exposed and a retracted position in which such portion of the mounting section is substantially covered by the cover section.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a distribution hub according to one example embodiment of the present disclosure.

FIG. 2 is a perspective view of the distribution hub of FIG. 1 in an extended position.

FIG. 3 is an exploded perspective view of the distribution hub of FIG. 1.

FIG. 4 is a perspective view of the distribution hub of FIG. 1 in an intermediate position between an extended position and a retracted position.

FIG. 5 is a partially exploded perspective view of a telecommunications pedestal enclosure according to another example embodiment of the present disclosure.

FIG. 6 is a perspective view of the telecommunications pedestal enclosure of FIG. 5 with the dome removed.

FIG. 7 is a perspective view of the telecommunications pedestal enclosure of FIG. 6 with the cover section in an extended position.

FIG. 8 is a perspective view of a telecommunications pedestal enclosure according to another example embodiment of the present disclosure.

FIG. 9 is a perspective view of a mounting leg of the telecommunications pedestal enclosure shown in FIG. 5.

FIG. 10 is a perspective view of the telecommunications pedestal enclosure of FIG. 6 with a portion of the base removed.

FIG. 11 is a partial perspective view of a distribution hub according to yet another example embodiment of the present disclosure.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “vertical,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

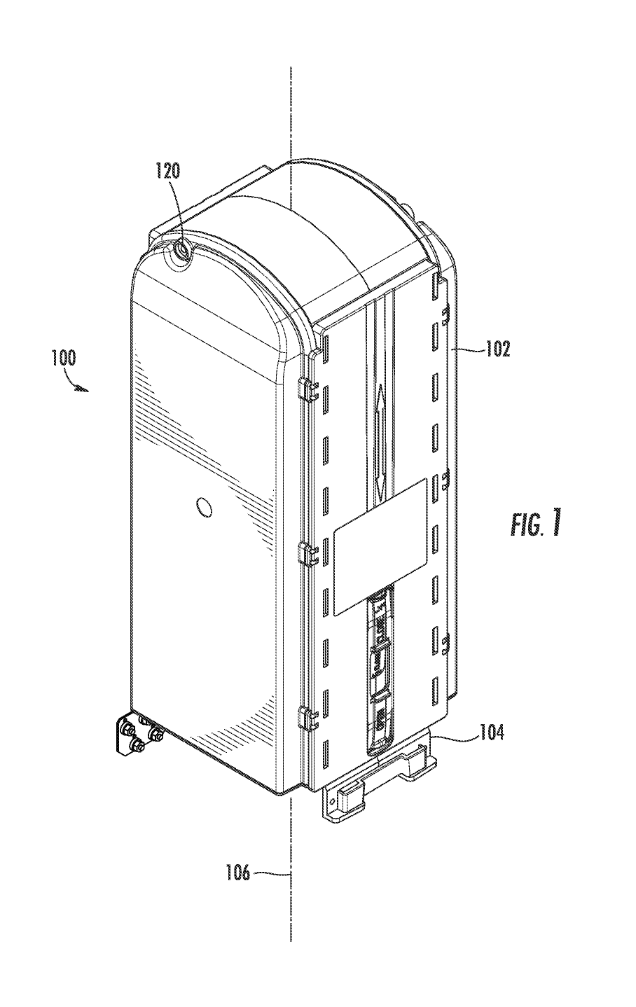

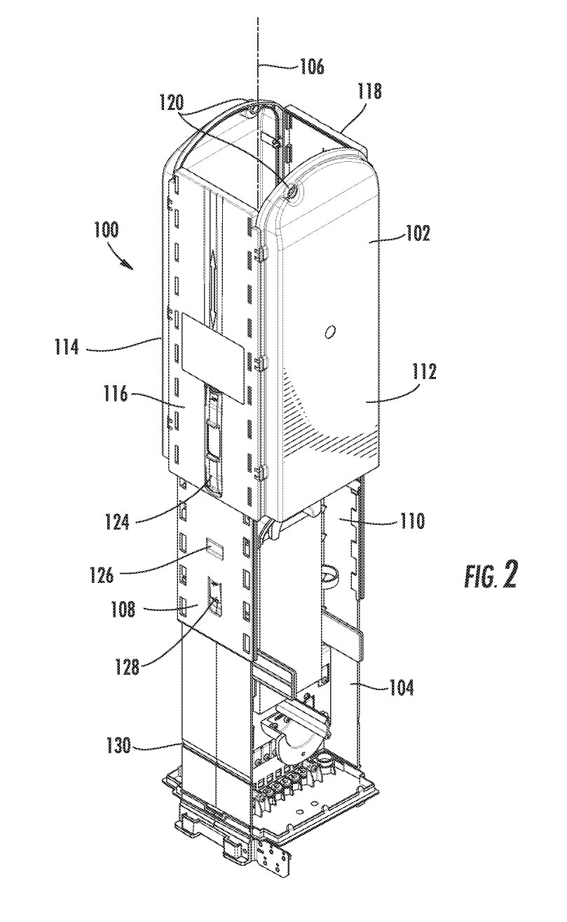

A distribution hub according to one example embodiment of the present disclosure is illustrated in FIGS. 1-3 and indicated generally by reference number 100. The distribution hub 100 includes a cover section 102 and a mounting section 104. The mounting section 104 is adapted to support telecommunications cables and/or equipment. The cover section 102 is coupled to the mounting section 104 to permit movement of the cover section relative to the mounting section 104 along an axis 106 and between an extended position in which a portion of the mounting section 104 is exposed and a retracted position in which said portion of the mounting section 104 is substantially covered by the cover section 102. The retracted position is illustrated in FIG. 1, and the extended position is illustrated in FIG. 2.

The cover section 102 and the mounting section 104 may be coupled together in any suitable manner to permit relative movement therebetween, and along the axis 106. In this particular example, the cover section 102 is coupled to the mounting section 104 in a telescoping arrangement that allows the mounting section to be received within and substantially covered by the cover section. It should be understood, however, that other telescoping and non-telescoping arrangements may be employed without departing from the scope of this disclosure.

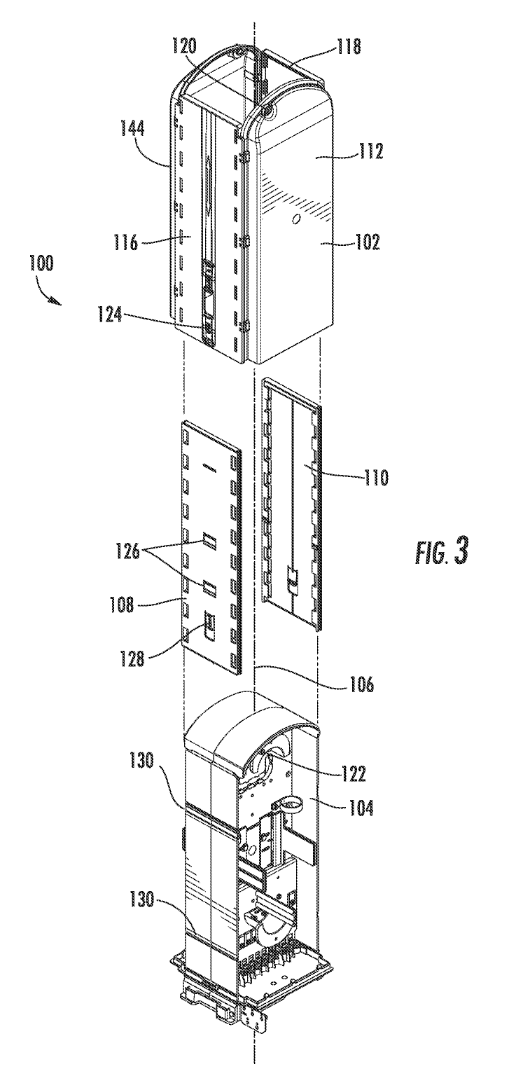

As shown in FIGS. 2 and 3, the distribution hub 100 includes two linkages 108, 110 coupled to the cover section 102 and the mounting section 104. The cover section 102 and the mounting section 104 are each moveable, e.g., slidable, etc., relative to the linkages 108, 110. The linkages 108, 110 are positioned to guide relative movement of the cover section 102 and the mounting section 104. In other embodiments, more, less or other types of linkages may be employed to guide movement of the cover section relative to the mounting section.

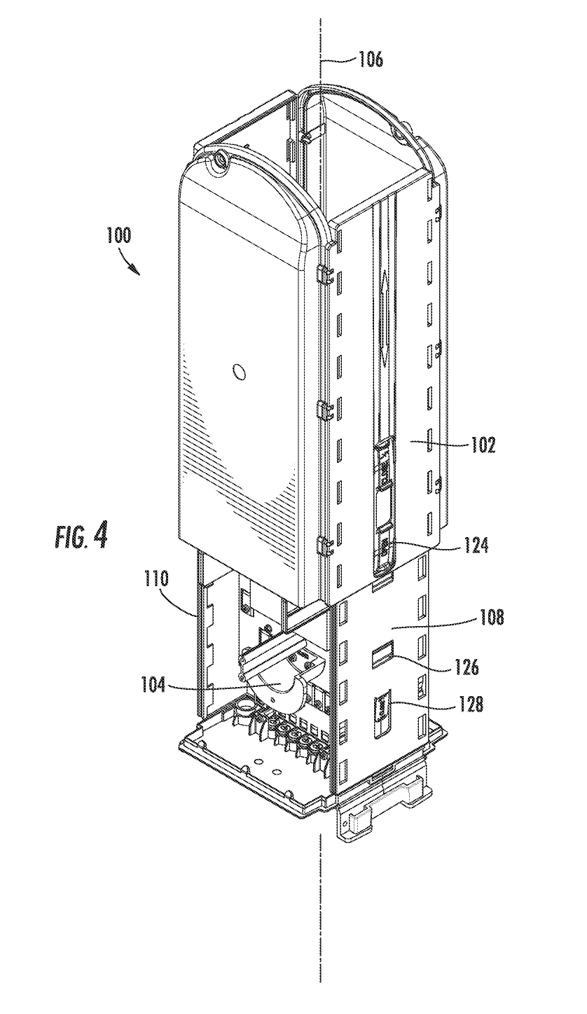

The cover section 102 is configured to be releasably retained in the extended position relative to the mounting section 104, as shown in FIG. 2. Retention of the cover section 102 in the extended position allows the technician to conveniently and effectively access the mounting section 104—without decoupling the cover section 102 from the mounting section 104 or holding the mounting section 104 relative to the cover section 102. Additionally, or alternatively, the cover section 102 may be releasably retained in one or more intermediate positions between the extended position and the retracted position. As shown in FIG. 4, for example, the cover section 102 is releasably retained in an intermediate position relative to the mounting section 104.

In this particular example, the cover section 102 includes two tabs 124. The tabs 124 are on opposite sides of the cover section 102. The tabs 124 communicate with one or more slots 126 defined by the linkages 108, 110 to releasably couple the cover section 102 to the linkages 108, 110. Further, each of the linkages 108, 110 includes a tab 128 to communicate with one or more slots 130 defined by the mounting section 104 to releasably couple the linkages 108, 110 to the mounting section 104. In combination, the tabs 124, 128 releasably retain the cover section 102, relative to the mounting section 104 in the extended position and/or one or more intermediate positions. Alternately, a different number and/or configurations of tab/slot pairs, or other suitable mechanisms may be employed to retain the cover section in one or more position, relative to the mounting section.

In one example, the cover section 102 may be releasably retained in a retracted position relative to the mounting section 104. Alternatively, the cover section may be un-retained in the retracted position, relying on gravity to maintain the cover section in the retracted position, when the axis is at least partially aligned with the force of gravity.

As shown in FIG. 2, when the cover section 102 is in the extended position, a technician has 360° access to the mounting section 104, including its slack limiting and mounting features, such as threaded or unthreaded apertures, etc. Conversely, when the cover section 102 is in the retracted position, the mounting section 104 is covered by the cover section 102, thereby covering and inhibiting access to all sides of the mounting section 104.

Alternatively, one or more sides of the cover section 102 (or portions thereof) may be omitted to expose a portion of the mounting section 104 when the cover section 102 is in the retracted position relative to the mounting section 104. In the example shown in FIG. 3, the cover section 102 includes a front side 112, a rear side 114, and opposite sides 116, 118. Due to the configuration of the mounting section 104, the linkages 108, 110 and the sides 116, 118, the rear side 114 may be removed without affecting relative movement between the cover section 102 (less the rear side 114) and the mounting section 104. In that event, a rear portion of the mounting section 104 would be accessible regardless of the relative position of the cover section 102 and the mounting section 104. Such an arrangement may be useful, for example, to provide craft separation between telecommunications cables and/or equipment mounted to the mounting section. In one example fiber optic application, splice connections coupled to a front side of a mounting section may be covered by the cover section in the retracted position, while patch connections on a rear side of the mounting section may be exposed. Further, the cover section may have a multi-piece construction with the sides of the cover section releasably coupled to one another (e.g., via a snap-fit arrangement, fasteners, etc.), so that a technician may remove a side if appropriate for a particular installation.

As shown in FIGS. 1 and 3, the cover section 102 includes apertures 120 positioned to align with apertures 122 of the mounting section 104, to receive a fastener (not shown) for securing the cover section 102 and the mounting section 104, when in the retracted position. Suitable fasteners include screws, bolts, rivets, etc.

The distribution hub 100 may be deployed indoors or outdoors, by itself or in combination with one or more types of telecommunications enclosures, for distributing fiber optic, copper and/or other types of telecommunications networks. For example, the distribution hub may be positioned within a telecommunications enclosure, such as a pedestal enclosure, etc., to protect the distribution hub from environmental conditions, such as weather, rodent, pests, debris, etc. FIG. 4 illustrates one example embodiment of a telecommunications pedestal enclosure 200 including the distribution hub 100. It should be appreciated, however, that other distribution hubs may be included in a telecommunications pedestal enclosure or other suitable telecommunications enclosure.

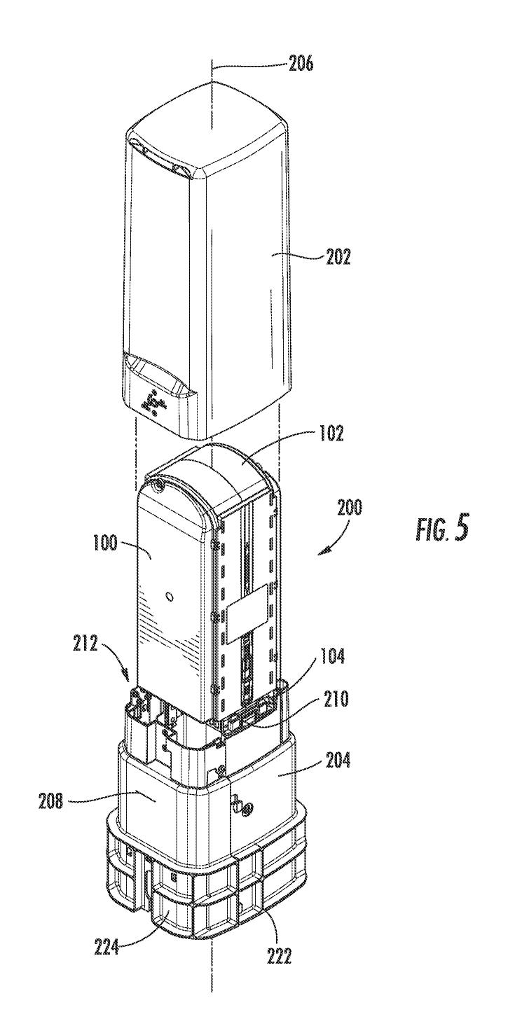

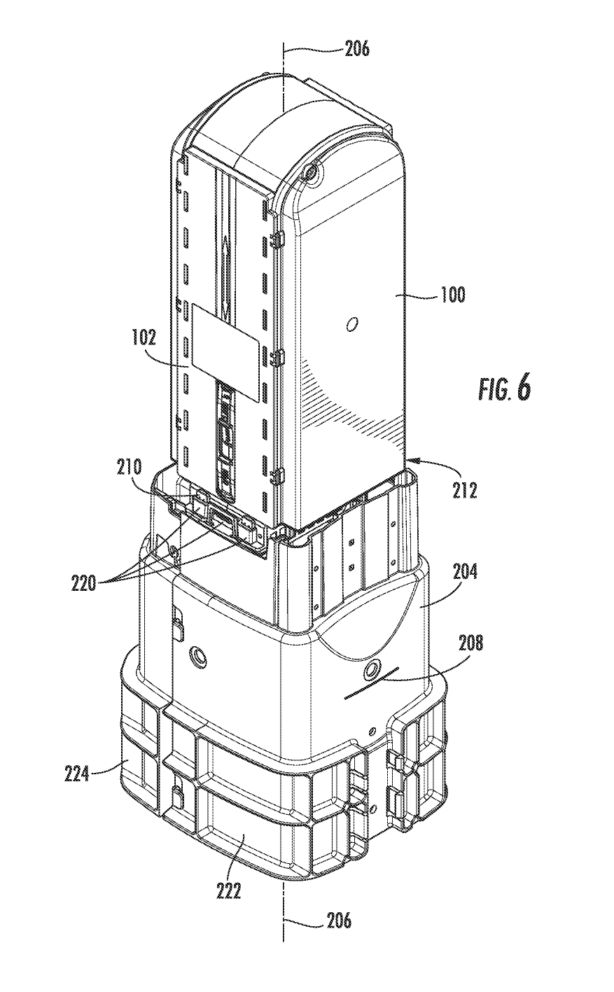

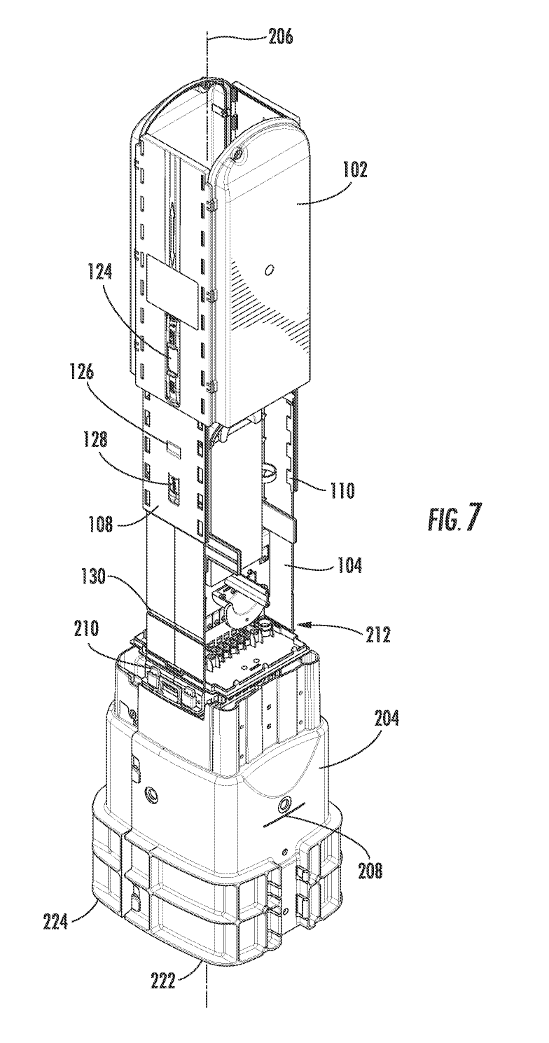

The pedestal enclosure 200 includes a base 204 for supporting the distribution hub 100 and a dome 202 releasably couplable to the base 204 for substantially enclosing the distribution hub 100 when the distribution hub 100 is supported by the base 204. The cover section 102 is moveable relative to the mounting section 104 along a substantially vertical axis 206 (aligned with axis 106) between an extended position, in which a portion of the mounting section 104 is exposed, and a retracted position, in which said portion of the mounting section 104 is substantially covered by the cover section 102. The retracted position is illustrated in FIGS. 5-6, while the extended position is illustrated in FIG. 7.

In this particular embodiment, the cover section 102 is moveable relative to the mounting section 104 and the base 204.

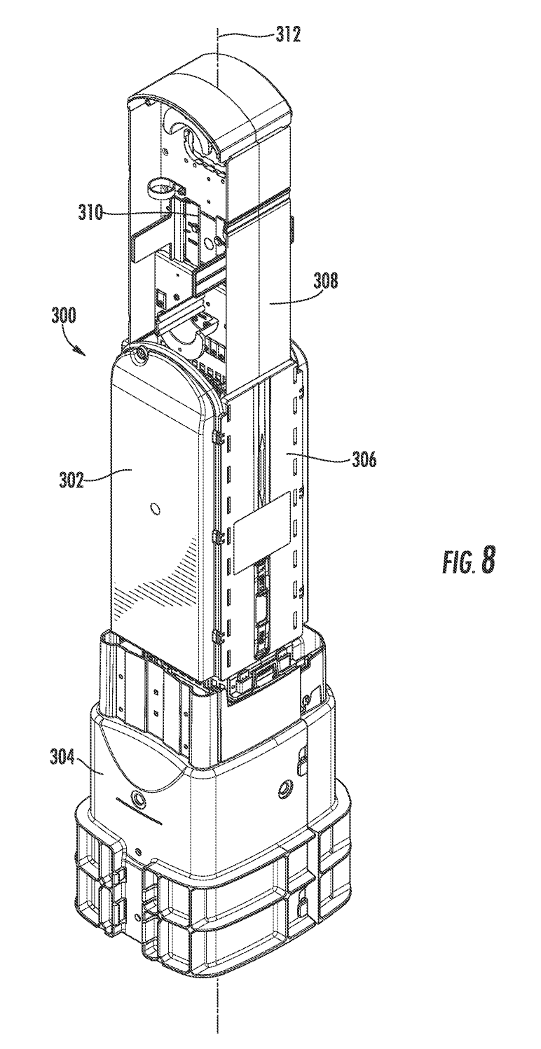

Alternatively, as shown in FIG. 8, a telecommunications enclosure 300 includes a distribution hub 302 and a base 304, supporting the distribution hub 302. The distribution hub 302 includes a cover section 306 and a mounting section 308 having a mounting area 310. The mounting section 308 is moveable relative to the cover section 306 and the base 304, along an axis 312. In this manner, in the extended position, the mounting section 308, and more particularly the mounting area 310, is spaced from the ground, so that a technician is able to access the mounting area 310, at a generally comfortable height above the ground.

While only the cover section 102 is moveable relative to the base 204 in the example of FIGS. 5-7 and the only the mounting section 308 is moveable relative to the base 304 in the example of FIG. 8, both the cover section and the mounting section may be moveable relative to the base (and each other) in other embodiments.

Referring again to FIG. 5, the base 204 is intended to be at least partially buried up to the ground line 208, during installation. Accordingly, the substantially vertical axis 206 is generally perpendicular to the ground (provided the ground is substantially horizontal). It should be appreciated that the axis in other embodiments may be any axis defined by the distribution hub, the cover section, the mounting section, and/or the enclosure. Accordingly, the axis may be offset from the substantially vertical axis 206 shown in FIG. 5, and/or oriented otherwise relative to the ground.

The distribution hub may be coupled to the base in any suitable manner, directly or indirectly. For example, and referring again to FIGS. 5-7, the distribution hub 100 may be coupled to the base 204, via two like mounting legs 210, 212. The mounting legs 210, 212 are releasably coupled to the base 204 and the mounting section 104. Accordingly, the mounting legs 210, 212 may be replaced, e.g., if damaged, etc., without having to replace the base 204 or the distribution hub 100. Additionally, because the two mounting legs 210, 212 are separate from the base 204 and the mounting section 104 (and not integrally formed therewith), the mounting legs 210, 212 may include a different, more rigid material, to reduce the risk of damage to the mounting legs 210, 212 during handling, installation or servicing of the pedestal enclosure 200.

Alternatively, one or more mounting legs may be integrally formed with or permanently fastened to one or both of the distribution hubs and the base.

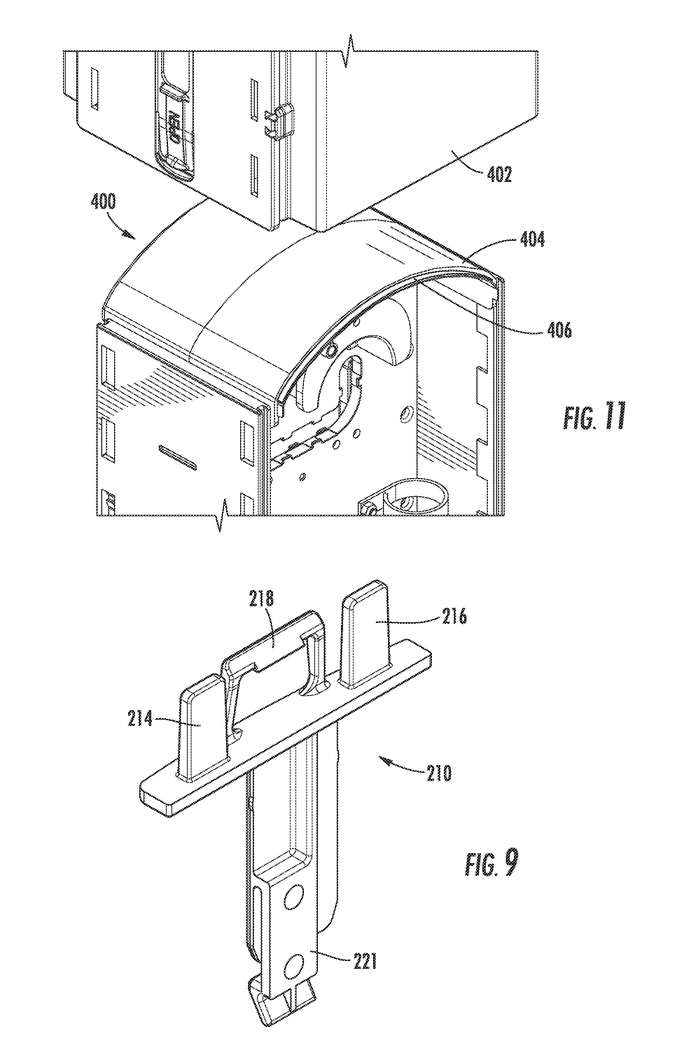

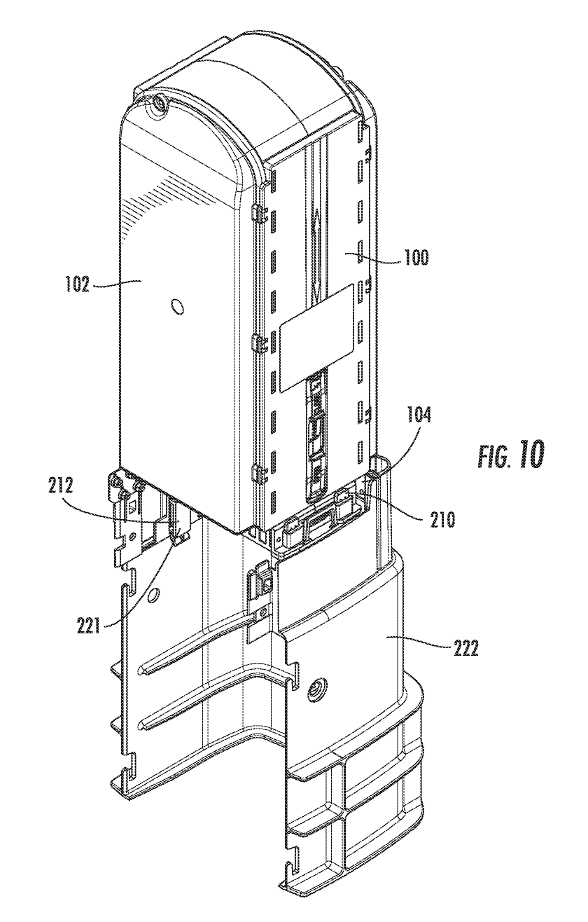

FIG. 9 illustrates the mounting leg 210. The mounting leg 210 includes two rigid protuberances 214, 216 and a biased member 218. As shown in FIGS. 6-7, the mounting section 104 includes openings 220 complimentary to each of the rigid protuberances 214, 216 and the biased member 218. When the mounting leg 210 is coupled to the mounting section 104, the biased member 218 is deflected during insertion and subsequently snaps into position to releasably engage the mounting section 104. Additionally, the mounting leg 210 includes a biased member 221 for coupling to a complimentary slot defined by the base 204 (visible in FIG. 10).

In the example embodiment of FIG. 9, the mounting legs 210, 212 are configured to be disengaged from the mounting section 104 of the distribution hub 100 from an external side of the base 204 and above the top edge of the base 204. In this manner, a technician is able order to remove the distribution hub 100 during installation or service, without accessing an internal chamber of the base 204.

Additionally, the base 204 includes a front portion 222 and a rear portion 224 releasably coupled together, as shown in FIG. 6. One of the front and rear portions 222, 224 may be removed from the other to provide access to telecommunications cables extending through an internal channel defined by the base 204. In the example shown in FIG. 10, the distribution hub 100 is supported by the front portion 222, and the rear portion 224 may be decoupled from the front portion 222 without removing the distribution hub 100 from portion 222. Accordingly, a technician can access telecommunications cables extending from the distribution hub 100 and through the internal channel of the base 204 for installation or service. When the cover section 102 is moveable as shown in FIG. 7, for example, and the rear portion 224 of the base 204 is removed, a technician may have substantial access to telecommunications cables and/or equipment on mounting section 104 and/or routed through the base 204.

Similarly, when the mounting section 308 is moveable relative to the cover section 306 and the base, as shown in FIG. 8, the cover section 306 may include a removable portion or a hinged portion to permit access to telecommunications cable extending from the mounting section 308 through the cover section 306 and into the base 304. Various other configurations of cover sections and bases, having pivotal or removable sides/portions may be employed in other embodiments to provide access to telecommunications cables and equipment supported by the mounting section.

FIG. 11 illustrates a distribution hub 400 including a cover section 402, a mounting section 404 and a gasket 406 positioned on a top edge of the mounting section 404. When in a retracted position, the gasket 406 contacts the cover section 402 to form a seal between the cover section 402 and the mounting section 404 to prevent ingress of debris, moisture, etc. Additionally, or alternatively, one or more gaskets may be coupled to the cover section 402 and/or the mounting section 404 at various joints to prevent ingress of debris, moisture, etc. In some embodiments, such as shown in FIG. 5, the cover section 102 and the mounting section 104 may be structured to form a sufficient seal that gaskets are omitted from joints between the cover section 102 and mounting section 104.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed:

1. A telecommunications pedestal enclosure comprising a distribution hub, a base for supporting the distribution hub, and a dome releasably couplable to the base for substantially enclosing the distribution hub when the distribution hub is supported by the base and the dome is releasably coupled to the base, the distribution hub including a cover section and a mounting section, the mounting section adapted to support telecommunications cables and/or equipment, the cover section moveable relative to the mounting section along an axis and between an extended position in which a portion of the mounting section is exposed and a retracted position in which said portion of the mounting section is substantially covered by the cover section.

2. The telecommunications pedestal enclosure of claim 1 wherein the cover section is configured to be releasably retained in the extended position relative to the mounting section.

3. The telecommunications pedestal enclosure of claim 1 wherein the cover section is moveable relative to the mounting section and the base when the distribution hub is supported by the base.

4. The telecommunications pedestal enclosure of claim 1 wherein the mounting section is moveable relative to the cover section and the base when the distribution hub is supported by the base.

5. The telecommunications pedestal enclosure of claim 1 wherein the distribution hub includes a linkage to guide relative movement between the cover section and the mounting section, and wherein the linkage is moveable relative to at least one of the cover section and the mounting section.

6. The telecommunications pedestal enclosure of claim 5 wherein the cover section, the mounting section, and the linkage form a telescoping structure.

7. The telecommunications pedestal enclosure of claim 6 wherein the telescoping structure is adapted to releasably retain the cover section in the extended position and at least one intermediate position between the extended position and the retracted position relative to the mounting section.

8. The telecommunications pedestal enclosure of claim 1 further comprising at least one mounting leg releasably coupled to the base and the mounting section.

9. The telecommunications pedestal enclosure of claim 8 wherein the mounting leg is configured to be disengaged from the mounting section from an external side of the base.

10. The telecommunications pedestal enclosure of claim 1 wherein at least one of the cover section and the mounting section includes a seal positioned to contact the other of the cover section and the mounting section when the distribution hub is in the retracted position.

11. The telecommunications pedestal enclosure of claim 1 wherein the base comprises a first portion and a second portion removably coupled to the first portion to permit access to a channel extending through the base, wherein the distribution hub is supported by the first portion, and wherein the second portion is removable from the first portion without removing the distribution hub from the first portion.

12. The distribution hub of claim 1 wherein the axis is a substantially vertical axis.

13. A distribution hub comprising a cover section and a mounting section, the mounting section adapted to support telecommunications cables and/or equipment, the cover section coupled to the mounting section to permit movement of the cover section relative to the mounting section along an axis and between an extended position in which a portion of the mounting section is exposed and a retracted position in which said portion of the mounting section is substantially covered by the cover section.

14. The distribution hub of claim 13, wherein the cover section is coupled to the mounting section in a telescoping arrangement.

15. The distribution hub of claim 14 wherein the cover section is configured to be releasably retained in an intermediate position between the extended position and the retracted position relative to the mounting section.

16. The distribution hub of claim 14 further comprising a first linkage coupled to the cover section and the mounting section for guiding movement of the cover section relative to the mounting section.

17. The distribution hub of claim 16 further comprising a second linkage coupled to the cover section and the mounting section for guiding movement of the cover section relative to the mounting section.

18. The distribution hub of claim 16 wherein the cover section and the first linkage include at least a first tab/slot pair, and the first linkage and the mounting section include at least a second tab/slot pair.

19. The distribution hub of claim 14 wherein the cover section includes a front portion and opposite side portions, but no rear portion, such that a rear portion of the mounting area is exposed when the distribution hub is in the extended position and when the distribution hub is in the retracted position.
